(19) United States
(12) Patent Application Publication
(10) Pub. No.: US 2026/0236473 A1
(43) Pub. Date: Aug. 13, 2026

(54) AUTOMATIC RUNTIME OPTIMIZATION FOR A DATABASE HOSTING SYSTEM

(71) Applicant: INTERNATIONAL BUSINESS MACHINES CORPORATION, ARMONK, NY (US)

(72) Inventors: Michael Haide, Jettingen (DE); Silke Wastl, Sindelfingen (DE); Monika-Lydia Dreiucker, Weil der Stadt (DE); Klaus Rindtorff, Weil im Schoenbuch (DE); Anushiya Gnana Amirtharaja, Boeblingen (DE); René Stephen Kienzle, Backnang (DE)

(21) Appl. No.: 19/077,319

(22) Filed: Mar. 12, 2025

(30) Foreign Application Priority Data
Feb. 13, 2025 (GB) 2502125.4

(51) Int. Cl. G06F 16/2455; G06F 9/445; G06F 9/50; G06F 11/34

(52) U.S. Cl. CPC G06F 16/24553; G06F 9/44505; G06F 9/5027; G06F 11/3466

(57) ABSTRACT

A method for runtime optimization of a database hosting system receives, by the database hosting system, a query having a query type and an expected performance value range and selects a first database having a first configuration parameter value that, when used to execute a previous query of the query type, resulted in an execution performance value within the received expected performance value range. The query is executed by the selected first database, and an execution parameter value for executing the query is measured. The database hosting system determines that the measured execution parameter value is below a lower threshold value of the received expected performance value range and, in response, identifies a second configuration parameter value for the first database such that executing a next query of the query type requires fewer computing resources than executing the query using the first configuration parameter.

### BACKGROUND

Aspects of the invention relate generally to runtime optimization of databases, and more specifically, to runtime optimization of database hosting systems.

In classical computing of the last century, an application and a database for managing required data may typically form a unit, e.g., having a 1:1 relationship. This is true for almost all types of databases. Nowadays, cloud computing environments are the norm, giving enterprises much more freedom in choosing a database or database management system for a specific task. Additionally, today's databases have a much wider range of performance tuning options.

Current database technologies typically provide key performance indicator (KPI) data for databases as well as services that compare the KPIs of many databases. They also provide support for making a decision upfront, but cannot support optimizing tuning parameters during runtime of the selected database. Other techniques focus on collecting, displaying of measured or real time performance indicators, as well as an analysis of optimization routines during maintenance times of the database.

### SUMMARY

Various embodiments are directed to a method of runtime optimization of a database hosting system. The runtime optimization comprises receiving, by the database hosting system, a query having a query type and an expected performance value range and selecting a first database having a first configuration parameter value that, when used to execute a previous query of the query type, resulted in an execution performance value within the received expected performance value range. The method of runtime optimization further comprises executing the query by the selected first database and measuring an execution parameter value for executing the query. The method further includes determining, by the database hosting system, that the measured execution parameter value is below a lower threshold value of the received expected performance value range and, in response, identifying a second configuration parameter value for the first database such that executing a next query of the query type requires fewer computing resources than executing the query using the first configuration parameter.

Further embodiments are directed to a system, which includes a memory and a processor communicatively coupled to the memory, wherein the processor is configured to perform the method. Additional embodiments are directed to a computer program product, which includes a computer readable storage medium having program instructions embodied therewith, the program instructions executable by a processor to cause a device to perform the method.

The above summary is not intended to describe each illustrated embodiment or every implementation of the present disclosure.

### BRIEF DESCRIPTION OF THE DRAWINGS

It should be noted that embodiments of the invention are described with reference to different subject matters. In particular, some embodiments are described with reference to method-type claims, whereas other embodiments are described with reference to apparatus-type claims. However, a person skilled in the art will understand from the above and the following description that, unless otherwise indicated, in addition to any combination of features belonging to one type of subject-matter, also any combination between features relating to different subject-matters, in particular, between features of the method-type claims, and features of the apparatus-type claims, is also considered to be disclosed by this document.

The aspects defined above and further aspects of the present invention are apparent from the examples of embodiments to be described below and are explained with reference to the examples of embodiments to which the invention is not limited.

Preferred embodiments of the inventive concept are described, by way of example only, and with reference to the following drawings to which the inventive concept—for which variations and at least partial substitutions exist—is not limited:

FIG. 1 is a flowchart illustrating a computer-implemented method for runtime optimization for a database hosting system, according to some embodiments.

FIG. 2 is a block diagram of a computer system for runtime optimization for a database hosting system, according to some embodiments.

FIG. 3 is a flowchart illustrating further details of the method of runtime optimization for a database hosting system, according to some embodiments.

FIG. 4 illustrates a block diagram of the database management system for runtime optimization for a database hosting system, according to some embodiments.

FIG. 5 is a block diagram illustrating a computing environment, according to some embodiments.

FIG. 6 illustrates a diagram of query execution times over time, according to some embodiments.

### DETAILED DESCRIPTION

There are several published documents relating to a method for runtime optimization for a database system. Document U.S. Pat. No. 8,572,068B2 discloses computer-implemented systems and associated operating methods using atomic query maps to identify and evaluate database plan robustness landmarks. The implemented system comprises logic that evaluates the robustness of the selected atomic query by measuring performance of atomic query execution in a predetermined range of runtime conditions that also include data characteristics. Additionally, the document US2022/0222232A1 discloses a data management apparatus using a first storage region. The first storage region stores tree-structured data. If new data should be added to an associated database in a second storage region, data about such added new data are also included into the pre-structured data of the first storage region.

However, these and other traditional technical approaches are not suitable for an automatic runtime optimization for database hosting systems, wherein the database hosting system can access several databases.

Hence, there may be a need to overcome the limitations given by the existing optimization methods for databases, in particular, to use adapted configuration parameters and/or another database to perform a given query.

In the context of this description, the following technical conventions, terms and/or expressions shall be used:

The term “runtime optimization” may denote an automatic way to reconfigure an existing combination of a database hosting system and one or more associated databases or database management systems. In particular, this may include a plurality of associated databases available to the database hosting system. Thereby, the runtime optimization may also comprise not only changing database configuration parameters but also using another database to achieve the same query result, potentially with fewer resources.

The term “database hosting system” may denote a computing system adapted for hosting, supporting and executing a plurality of databases or database management systems. The database hosting system may be a real hardware system with an operating system and supporting components; alternatively, the database hosting may be a virtualized database hosting system. The database hosting system may be an on-premise system but may also be implemented in a cloud computing environment, operated on-premise or deployable in an external cloud computing center.

The term “query” may denote a request to a database or database management system in order to return a result matching the boundaries defined by the query. Typically, SQL statements or other database management specific query languages are used to enable the response to the request or query.

The term “query type” may denote that the query matches certain conditions. The query type may be used to compare similar queries. The similarity may be predefined by using configuration parameters, like access to the same database table(s) (or database space), similar extraction conditions and/or values, a similar number of database tables involved in the query, and so on. A predefined set of query types may be defined as part of the configuration of a database management system and/or database hosting system. Optionally, the set of query types may be extended dynamically and automatically throughout the operation of a database.

The term “expected performance value range” may denote a defined lower and upper limit for the expected performance value. An example may illustrate this in a more comprehensive way: when comparing expected values and actually measured performance values (or any other KPI value), then the measured actual values may first be filtered to remove outliers, and then a moving average value may be determined. Only when the value of the moving average deviates by a certain number of standard deviations (in particular, the upper and/or lower threshold value), actions may be triggered to adjust the system parameter(s) in order to improve the overall system performance. If the lower threshold is exceeded (i.e., the database performance is repeatedly better than required), and measures may be initiated to shift the system configuration towards the (technically) more or most cost-effective solution. This may also go along with accepting a (slight) drop in the achievable performance which may then be back within the expected performance value range. As an example, the measured execution time for executing the query may be used as performance value.

The term “database” may denote any type of data storage, like relational databases, a hierarchical database, NoSQL databases and other advance database concepts, as well as data in a file system. The terms database (DB) and database management system (DBMS) are used equivalently herein.

The term “execution performance value” may denote a measurable parameter value during or after the execution of a query. A typical execution parameter value may be the required execution time for a given query or query type. However, also other execution parameter values may be evaluated, such as used resources of any kind.

Embodiments of the inventive concept can be described as follows:

According to an embodiment of the disclosure, a computer-implemented method for runtime optimization for a database hosting system is provided. This embodiment comprises receiving a query by the database hosting system, where the query has a query type, and receiving an expected performance value range for the query. The embodiment also comprises selecting, by the database hosting system, a database having an associated related configuration parameter value that was used for a previous query of equal query type, wherein a resulting execution performance value was within the expected performance value range, and executing the received query by the selected database. Additionally, the embodiment comprises measuring the execution parameter value for executing the query, and if the execution parameter value for executing the query is below a lower threshold value of the expected performance value range, identifying, by the database hosting system, a different configuration parameter value for the database such that fewer computing resources are required.

According to another embodiment of the disclosure, a database management system for runtime optimization for a database hosting system is provided. This embodiment comprises a processor and a memory, communicatively coupled to the processor, wherein the memory stores program code portions that, when executed, enable the processor to receive a query by the database hosting system, where the query has a query type, and receive an expected performance value range for the query. The processor is further enabled to select, by the database hosting system, a database having an associated configuration parameter value that was used for a previous query of equal query type, wherein a resulting execution performance value was within the expected performance value range. The processor may also be enabled to execute the received query through the selected database, and to measure the execution parameter value for executing the query. Last but not least, the processor is enabled—upon determining that the execution parameter value for executing the query is below a lower threshold value of the expected performance value range—to identify, by the database hosting system, a different configuration parameter value for the database such that fewer computing resources are required.

It may also be noted that the system can also comprise a plurality of processors so that the performed tasks may also be performed by the one or more processors.

The proposed computer-implemented method for runtime optimization for a database hosting system may offer multiple advantages, technical effects, contributions and/or improvements:

If compared to traditional database tuning concepts, the optimization process may not be limited to a single database. The proposed concept extends the idea of database optimizations to a variety of different databases that can be accessed by a database hosting system. Thereby, the databases may be of different types with different performance characteristics and/or resource requirements. The only requirement for the databases is that they may be configurable to return the same query results, given that the same data are accessible by the database.

The proposed concept may also be used to decide which expected performance value or which expected performance parameter value should be used as basis for the runtime adaptation of the database properties or even switch to another database system. The expected query execution time may be the predominant performance value for the dynamic optimization. However, also other performance evaluation criteria may be used. Hence, also other aspects may be reflected in the optimization process, like used system and/or network and/or storage resources as well as environmental or even commercial aspects. Therefore, the most (technical) cost-effective implementation may be chosen under a given set of technical—in some cases also organizational or commercial combined with technical—requirements.

These properties can make embodiments of the disclosure particularly useful in cloud computing environments, where a variety of different database types can be used by the same database hosting system.

This can also take into account the fact that changes to an implementation that alter the data set, e.g., using a different database, are technically very “expensive” operations and are therefore not carried out for a single query, but instead only when a certain threshold is reached. This threshold value may be taken from multiple performance measurements, may include the sliding average window to exclude measured outlier values, and may include a hysteresis in the threshold values for each implementation.

The primary optimization measures that may be used are initially adjusting classic performance parameters or configuration data such as buffer sizes, in-memory computing sizes, number of central processing units (CPUs), parallel threads used, etc. However, if these adaptations are determined to not be sufficient to achieve the expected theory response time, and/or if these adaptations are too extreme for the chosen execution environment, a change of the underlying database can also be made. Hence, embodiments of the proposed optimization process rely on a two-step approach: (i) optimize the already used database, and (ii) if this does not deliver the expected results, switch automatically to another database.

In the following, additional embodiments of the inventive concept—applicable for the method as well as for the system—will be described.

In an example of the computer-implemented method, the identification of the different configuration parameter value for the database may comprise selecting another database requiring fewer computing resources. Instead of the identification of the single different configuration parameter value, the method may also comprise identifying a plurality and/or a combination of different configuration parameter values. A weighing of the different configuration parameter values may result in a joint decision parameter value on which basis the other database for execution of the query may be determined and selected. As a further alternative, the determination of the other database for executing the query may also be performed based on a (technical) price/performance ratio. For example, the selection of a more resource-efficient database hosting system can also be based on other criteria, such as lower energy consumption, fewer critical communication/network paths, greater use of alternative energy sources (i.e., environmentally friendly), a geographical region with a more stable environment, or even monetary costs or payment terms. Hence, the term “price” should be interpreted in a wide range of meanings. Given the strong competition among platform providers also offering database hosting systems, such freedom of decision can be a significant advantage for enterprises using external resources like databases and/or associated database management systems. In this sense, the fundamental concept of selecting an underlying technology stack may also be applicable for network resources, processing resources, specific application program resources for service-oriented computing components, and the like.

In an example, the computer-implemented method may also comprise storing the query type, the selected configuration parameter value—or a plurality thereof—for the database, and the measured execution parameter value in a query parameter storage associated with the database hosting system. This may allow the determination of an adapted configuration parameter value—or a plurality thereof—to be based on historical data. This can make it possible to better adapt the database performance to the given framing conditions. It is also noted that the query parameter storage may be managed as part of the database, a database hosting system, and/or another external system, e.g., a system management and infrastructure computing environment.

Embodiments of the proposed concept may also work in the upper right direction. In an example, if the achievable query response time (i.e., the expected performance value) may not be achievable by the given database configuration, the other database may be one delivering a better performance, even under the condition of higher technical requirements.

In an example, the computer-implemented method may also comprise removing outliers (e.g., measured outlier values) from the query parameter storage. This activity may also be applied to a newly measured actual value determined as part of the proposed method. Hence, an outlier may not be allowed as basis for a reconfiguration of the query execution configuration to control a reconfiguration of the database parameters in some embodiments. Lower and upper limits for outliers may be definable as part of the database system configuration and/or the database hosting system configuration.

In an example, the computer-implemented method may also comprise building a moving average performance value from a plurality of measured execution parameter values relating to the selected database and the related query type (e.g., except the outliers). The moving average performance value may be stored in the query parameter storage which may be associated with the database hosting system. This determination may be performed in parallel to the normal database operation without delaying query executions.

In combination with the previous embodiments and according to further embodiments, the method may also comprise, upon moving the average parameter value relating to the selected database and determining that the related query type may be below a lower threshold value of the expected performance value range, identifying another database (a database other than the selected one) having another related configuration parameter value for the query type and a comparable expected performance value range. This comparable expected performance value range may have the same lower and upper limits, optionally with a comparably small predefined difference value. This way, the identified other database may be used for an execution of subsequent queries of the query type and the selected expected performance value range. It may also be noted that using a value range instead of an exact value helps to avoid oscillation of the system. Thus, the range acts as a hysteresis so that if there is a small difference in the measured execution time compared to the expected performance value—e.g., the expected execution time—another database will not immediately be selected. Particularly, adaptations to the database system or a selection of another database may only be performed if the measured performance value is, e.g., a certain predefined number of standard deviations away from the middle of the given range for a query/query type.

It may also be noted that the expected performance value range may be configured independently of the used database. Under this condition, the method and/or system may choose a different database and/or database type, regardless of the database used. This may allow a switching between databases depending on other optimization parameters.

In an example of the computer-implemented method, the database and the other database may be selected out of the group comprising a row-oriented database, a column-oriented database (e.g., in general, relational databases), a SQL engine—e.g., Apache Spark Data Lakehouse architecture, Presto, etc.—a NoSQL database, a graph database, an object-oriented database, and an in-memory DB, such as DuckDB or Mnesia (the formerly used in-memory database in RabbitMQ). Hence, the proposed concept may be used with a wide variety of different DBMSs.

In an example of the computer-implemented method, the configuration parameter value of the database may be selected out of the group consisting of a size of available memory—e.g., cache or in-memory capacity—a buffer size, a CPU type, a number of CPUs or kernels, a number of threads per CPU or kernel, a number of partitions in the DB (e.g., using Spark, Presto, etc.), a number of shards (in particular, for NoSQL databases), and a geographical location of the database. The configuration parameter value may also be a number of all executors in a dynamic scale-out, the number of kernels in a used computing instance, etc. in some embodiments. For example, specifying the geographical location as a value of configuration parameters may be advantageous to ensure a shorter distance between the location of the database and a user's computing site. This configuration parameter may also be used if the location may ensure more suitable and/or matching legal conditions (e.g., privacy requirements) for operating data in the database.

In an example of the computer-implemented method, the execution parameter value may be an execution time or required computing and/or network resources. However, it may also be possible to define commercial aspects in addition to, and/or correlated with, the technical aspects for the optimization process, e.g., a price for a license for the use of the database and required resources. This may play a significant role in cloud computing environments.

In an example of the computer-implemented method, if the received expected performance value range (e.g., the expected query response time) for the query is below a practical maximum performance value (corresponding to a practical minimum query time) independent of the selected database—i.e., the expected performance cannot be met—the method may comprise generating an alarm signal. This alarm signal may be generated in any form in order to inform a systems manager that the requested performance value may not be achievable. It may also be used for tracking the behavior of the system (including query requesting applications and/or related middleware) over time using logging information.

In the following, a detailed description of the Figures will be given. All instructions in the Figures are schematic. Firstly, a block diagram of the computer-implemented method for runtime optimization for a database hosting system, according to some embodiments, is given. Then, further embodiments, including a database management system for runtime optimization of a database hosting system will be described.

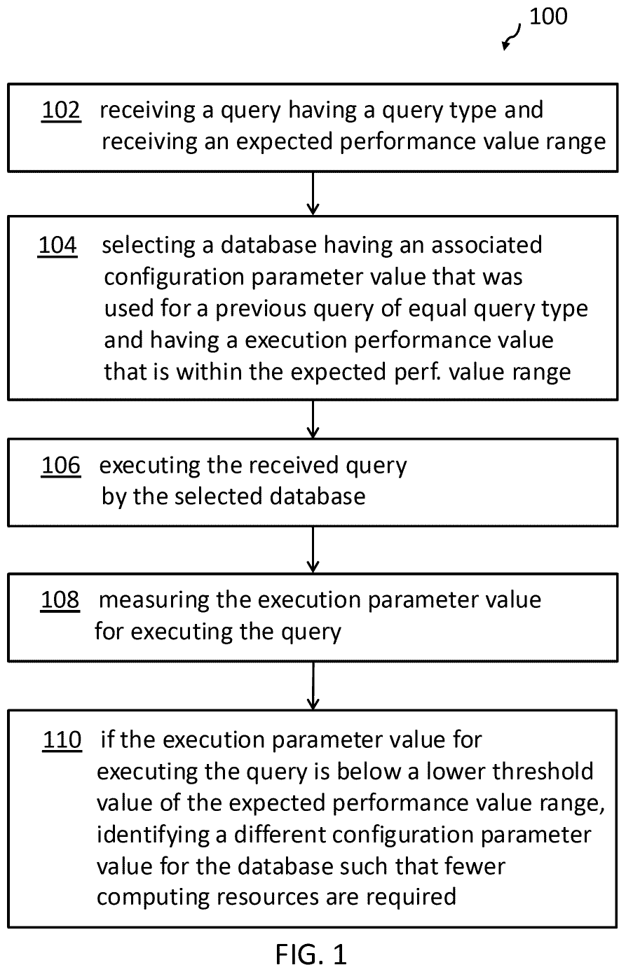

FIG. 1 shows a block diagram of a computer-implemented method 100 for runtime optimization for a database hosting system, according to embodiments. In short, the runtime optimization can be directed to an execution time, required technical resources and/or a price/performance ratio (e.g., combining technical and commercial aspects), or an execution of the query.

The method 100 includes receiving, at block 102, a query by the database hosting system, where the query has a query type, and receiving an expected performance value range—i.e., a minimum and maximum value—for the query. The expected performance value range can be received as part of the query itself in the form of an extension of the query language used. In other embodiments, instead of receiving the expected performance value range, the expected performance value range may be determined from a look-aside storage that specifies for each query type, and optionally asset types the query refers to, a performance value range. The term “query type” may here be used for a categorization of the query in order to facilitate a determination of a similar query.

The method 100 also includes selecting, at block 104, by the database hosting system, a database having at least one associated configuration parameter value that was used for a previous query of equal or comparable query type, and having a resulting execution performance value that was within the expected performance value range. Instead of including only a single expected performance value, the selecting (104) can rely on the expected performance value having a lower and an upper limit. This has the advantage of using the hysteresis effect. As a consequence, the number of system adaptations due to a mismatch between the expected performance value and the measured performance value can be adjusted dynamically. Hence, not each mismatch will result in a change of the used database or DBMS. All possible adjustments and changes remain user-controlled/user configured.

Moreover, the method 100 includes executing, at block 106, the received query through the selected database and measuring, at block 108, the execution parameter value to execute the query. Advantageously, the execution parameter value can be at least the execution time for executing the query. In some embodiments, further execution parameter values, such as required resources, can be measured simultaneously.

The method also includes identifying, at block 110, by the database hosting system, a different configuration parameter value for the database such that fewer computing resources are required for an execution of the next query of the same type in response to determining that the execution parameter value for executing the query is below a lower threshold value of the expected performance value range. The identification of a different configuration parameter value or a set thereof can be equivalent to a once-in-a-time manual database performance optimization. However, in some embodiments, such tuning activities may be performed completely automatically, independent of all manual intervention, and an optimization is generally possible for each query execution at runtime, which is technically and practically impossible for operator-initiated tuning activities.

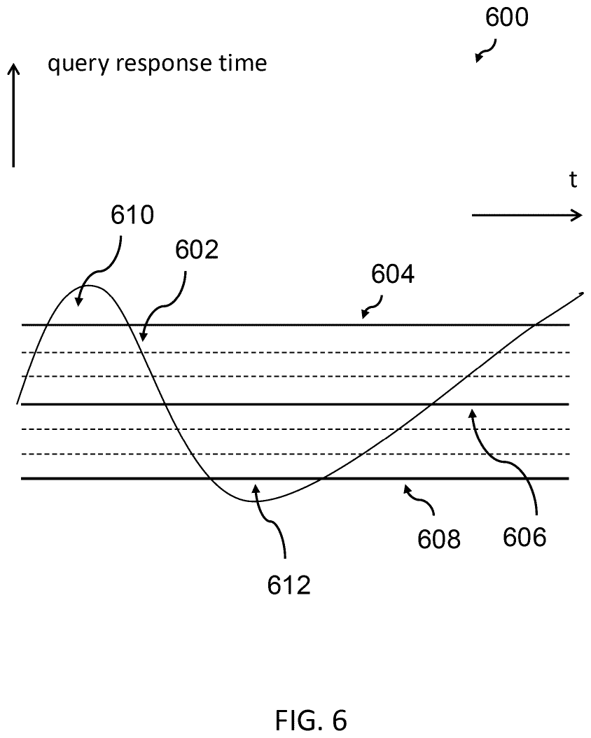

FIG. 6 illustrates a diagram 600 of query execution times over time, according to some embodiments. Diagram 600 shows changing measured execution time values 602 (with a smoothed curve) over time t, which represents the x-axis. The y-axis represents the execution time for queries or query response times. Additionally, an upper threshold value 604, the expected execution value or expected run time value 606, and a lower threshold value 608 is shown. During the time (area 610) when the measured execution time value 602 is above the upper threshold value 604, the performance of the database can be repeatedly worse than required or expected, and an adjustment of the database system parameters can be advisable in order to increase the query performance. Also, an alert can be generated when the measured execution time value 602 is above the upper threshold value 604 in some embodiments.

If, on the other hand, the performance (e.g., the measured execution time value 602) is repeatedly better than required (e.g., low execution time value in the area 612 of FIG. 6), a switch to a more cost-effective solution should be made. The more cost-effective solution may primarily be an improvement in a technical sense (e.g., requiring fewer resources), but can also be an improvement in an economical and/or environmental sense.

That is, in some embodiments, only if the value of the measured performance—here the query execution time—is falling a certain number of standard deviations (up to the lower threshold value) below the expected performance value (equivalent to the lower threshold value 608), an action to adjust the system parameters is triggered to achieve a “good enough” response time (within the performance parameter range) and thereby require fewer resources. Hence, using this measure, an overperformance (as shown in area 612) or an underperformance (as shown in area 610) can effectively be addressed.

As a further option, if the value of the measured performance falls below the lower threshold (the performance is repeatedly better than required), a potential next step of optimization, e.g., a switch to another database as a more cost-effective solution, can be possible. In parallel, a drop in the achievable performance can be expected and accepted.

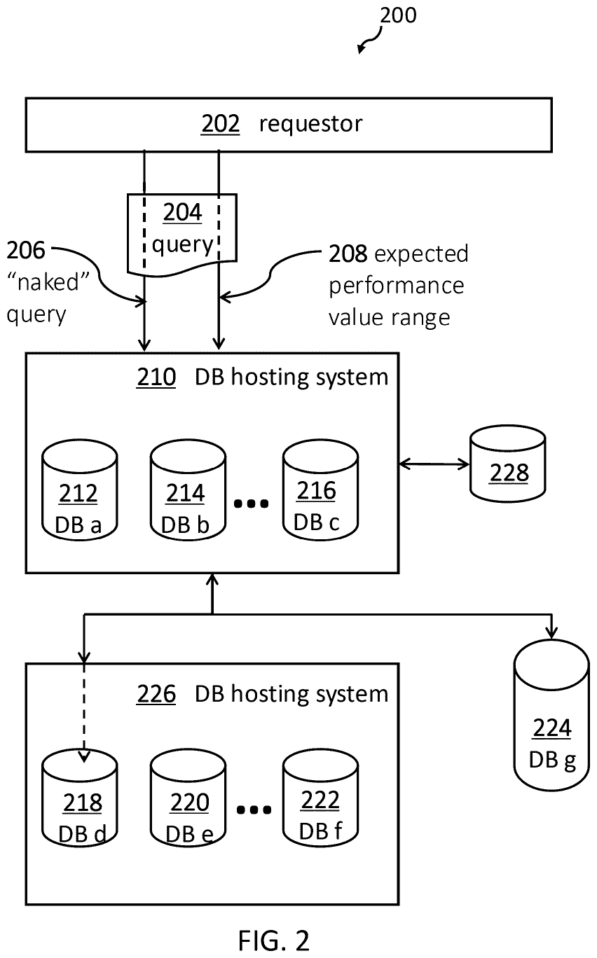

Turning now to FIG. 2, a block diagram of a computing environment 200 for executing the method 100 for runtime optimization of a database hosting system is shown, according to some embodiments. A query 204 can originate from a requestor 202. The requestor 202 may be a user operating a user interface, an application, or any other programmed service. In contrast to a traditional or “naked” query 206, the query 204 from the requestor 202 to the database hosting system 210, and hence to the database management system, includes an expected performance value range 208. In some embodiments, this can be an expected execution time value. In other examples, the expected performance value range 208 may also relate to required resources or other measurable parameters during the execution of a query. Hence, not only a single measured parameter value may be determined, but typically a set thereof.

Given the above-described operations, the database hosting system 210, or a subsystem thereof, determines which database, DB a 212, DB b 214, or DB c 216, or associated DBMS shall be used for the query at hand.

In some embodiments, the database hosting system 210 can be in cooperation with another database hosting system 226 in order to select a more appropriate DBMS, DB d 218, DB e 220, or DB f 222. Alternatively, the selected DBMS or database (DB g 224) may also be located outside the database hosting system 210 and may be part of a different hosting platform.

As a further option, a query parameter storage 228 is shown as an optional external component to the database hosting system.

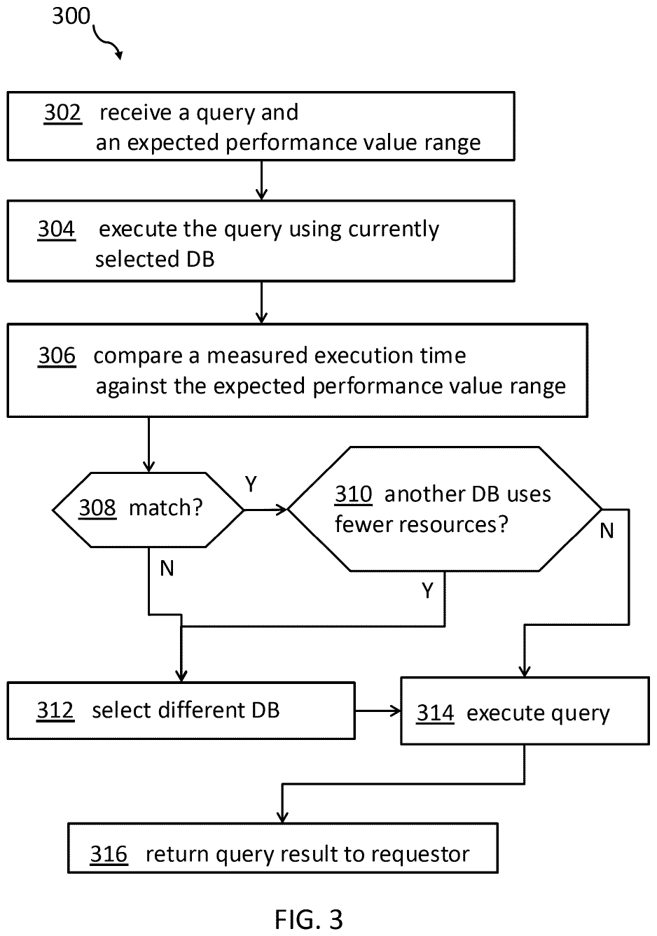

FIG. 3 shows a block diagram of a more detailed method 300 of optimization, according to some embodiments. Here, the method 300 starts with receiving, at block 302, a query and a value for the expected performance value range. The query is executed, at block 304, using a currently selected database system. Here too, the measured execution time—as an example of the performance value—is compared, at block 306, with the expected performance value range. If it is determined, at block 308, that the measured execution time is within (“matches”) the expected performance value range (308: Y) a determination, at block 310, can be made whether the same operation (achieving the same query results as at 304) can be performed with another database using fewer resources. If that is the case (310: Y), a different database management system or database (e.g., the one using fewer resources) can be selected, at block 312, the query can be executed, at block 314, with the different database, and the result can be returned to the requestor, at block 316. A different database can also be selected, at block 312, if the measured execution time is not within the expected performance value range (308: N).

If, on the other hand, the same operation (achieving the same query results as at 304) cannot be executed by another database using fewer resources (308: Y, 310: N), the pending query will be executed, at block 314, with the same database used for the executing the query at 304, and the result will be returned, at block 316, to the requestor.

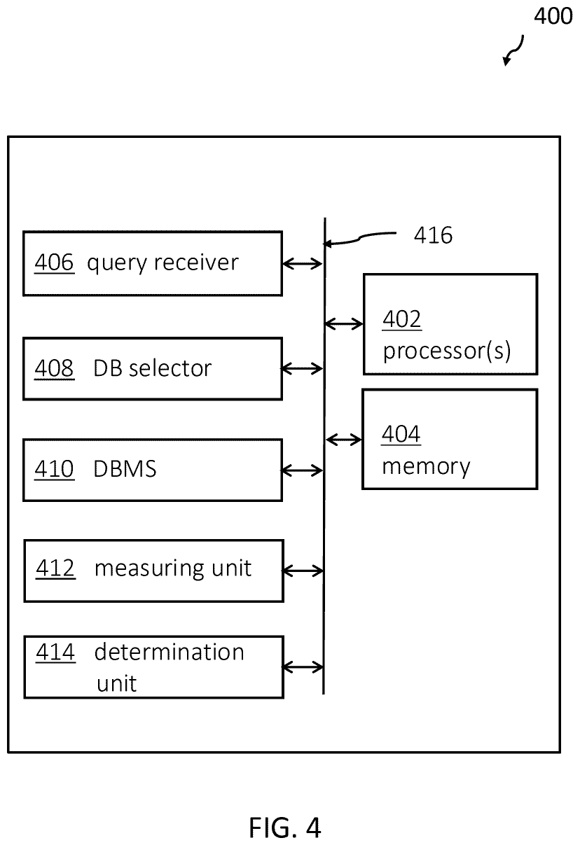

FIG. 4 shows a block diagram of a database management system 400 for runtime optimization of a database hosting system, according to some embodiments. The database management system 400 includes a processor 402 and a memory 404, communicatively coupled to the processor 402, storing portions of program code that, when executed, enable the processor 402 to receive a query by the database hosting system—more specifically, by a query receiver 406—where the query has a query type, and to receive an expected performance value range for the query. The program code also enables the processor 402 to select, by the database hosting system—more specifically, by a database selector 408—a database or database management system 410 having an associated configuration parameter value that was used for a previous query of the same query type, wherein a resulting execution performance value was within the expected performance value range.

The processor 402 is also enabled to execute the received query by the selected database, and to measure the execution parameter value, e.g., the query performance time, for executing the query. The measurement can be performed by a measuring unit 412.

Further, the processor 402 is enabled to determine, through the database hosting system or a system thereof—in particular, the database selector 408—a different configuration parameter value for the database such that fewer computing resources are required when the execution parameter value for executing the query is below a lower threshold of the expected performance value range. The determination unit 414 can be used for performing this identification.

In some embodiments, all functional units, modules and functional blocks—in particular, the processor or processors 402, the memory 404, the query receiver 406, the database selector 408, the database or database management system 410, the measuring unit 412, and the determination unit 414—can be communicatively coupled to each other for signal or message exchange in a selected 1:1 manner. Alternatively, the functional units, modules and functional blocks can be linked to a system-internal bus system 416 for a targeted signal and/or message exchange.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called mediums) collectively included in a set of one or more storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

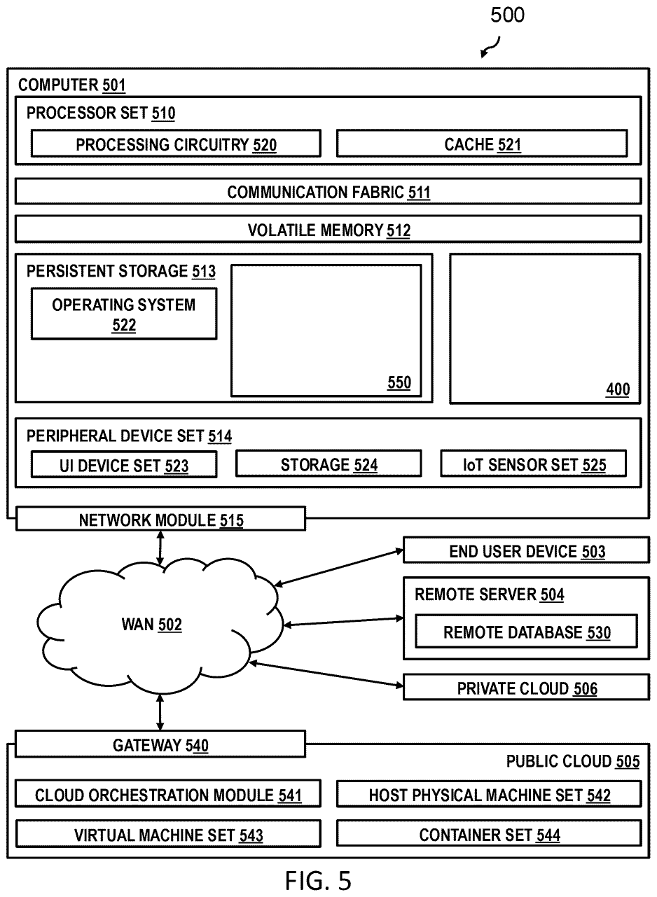

FIG. 5 shows a computing environment 500 comprising an example of an environment for the execution of at least some of the computer code involved in performing the inventive methods, such as the code block 550, for runtime optimization for a database hosting system as shown in, e.g., computer-implemented method 100 (FIG. 1).

In addition to block 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip”. In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer—implemented method, such that the instructions thus executed will instantiate the methods specified in flowcharts and/or narrative descriptions of computer—implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 550 in persistent storage 513.

COMMUNICATION FABRIC 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid-state storage devices. Operating system 522 may take several forms, such as various known proprietary operating systems or open-source Portable Operating System Interface type operating systems that employ a kernel. The code included in block 550 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (e.g., embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The database management system 400 for runtime optimization for a database hosting system (compare FIG. 4) can be an operational sub-system of the computer 501 and may be attached to a computer-internal bus system.

The terminology used herein is for the purpose of describing particular embodiments only and is not intended to limit the invention. As used herein, the singular forms a, an and the are intended to include the plural forms as well, unless the context clearly indicates otherwise. It will further be understood that the terms comprises and/or comprising, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

1. A method for runtime optimization of a database hosting system, comprising:
receiving, by the database hosting system, a query having a query type and an expected performance value range for the query, wherein lower performance values indicate better performance;
selecting, by the database hosting system, a first database having a first configuration parameter value that, when used to execute a previous query of the query type, resulted in an execution performance value within the received expected performance value range;
executing the query by the selected first database;
measuring an execution parameter value for the executing the query;
determining, by the database hosting system, that the measured execution parameter value is below a lower threshold value of the received expected performance value range; and
adjusting a configuration of the database hosting system, wherein the adjusting comprises identifying, by the database hosting system in response to the determining, a second configuration parameter value for the first database such that executing a next query of the query type requires fewer computing resources than the executing the query using the first configuration parameter.

2. The method of claim 1, wherein the identifying the second configuration parameter value comprises selecting a second database requiring fewer computing resources than the first database.

3. The method of claim 1, further comprising storing the query type, the first configuration parameter value, and the measured execution parameter value in a query parameter storage relating to the database hosting system.

4. The method of claim 3, further comprising removing outliers from the query parameter storage.

5. The method of claim 3, further comprising building a moving average performance value from a plurality of measured execution parameter values relating to the first database and the query type.

6. The method of claim 5, further comprising:
determining that the moving average performance value is below the lower threshold value of the received expected performance value range; and
in response, identifying a second database having a related configuration parameter value for the query type and a comparable expected performance value range to the received expected performance value range for the query.

7. The method of claim 6, wherein the first database and the second database are selected from the group consisting of a row-oriented database, a column-oriented database, an SQL engine, a NoSQL database, a graph database, an object-oriented database, and an in-memory database.

8. The method of claim 1, wherein the first configuration parameter value is selected from the group consisting of a size of available memory, a buffer size, a central processing unit (CPU) type, a number of CPUs, a number of threads per CPU, a number of partitions of the first database, a number of shards, and a geographical location of the first database.

9. The method of claim 1, wherein the measured execution parameter value is an execution time or specification of required resources.

10. The method of claim 1, further comprising:
determining that the received expected performance value range is below a practical maximum performance value independent of the first database; and
in response, generating an alarm signal.

11. A system for runtime optimization of a database hosting system, comprising:
a processor set;
one or more computer-readable storage media; and
program instructions stored on the one or more computer-readable storage media to cause the processor set to perform operations comprising:
receiving, by the database hosting system, a query having a query type and an expected performance value range for the query, wherein lower performance values indicate better performance;
selecting, by the database hosting system, a first database having a first configuration parameter value that, when used to execute a previous query of the query type, resulted in an execution performance value within the received expected performance value range;
executing the query by the selected first database;
measuring an execution parameter value for the executing the query;
determining, by the database hosting system, that the measured execution parameter value is below a lower threshold value of the received expected performance value range; and
adjusting a configuration of the database hosting system, wherein the adjusting comprises identifying, by the database hosting system in response to the determining, a second configuration parameter value for the first database such that executing a next query of the query type requires fewer computing resources than the executing the query using the first configuration parameter.

12. The system of claim 11, wherein the identifying the second configuration parameter value comprises selecting a second database requiring fewer computing resources than the first database.

13. The system of claim 11, wherein the operations further comprise storing the query type, the first configuration parameter value, and the measured execution parameter value in a query parameter storage relating to the database hosting system.

14. The system of claim 13, wherein the operations further comprise removing outliers from the query parameter storage.

15. The system of claim 13, wherein the operations further comprise building a moving average performance value from a plurality of measured execution parameter values relating to the first database and the query type.

16. The system of claim 15, wherein the operations further comprise:
determining that the moving average performance value is below the lower threshold value of the received expected performance value range; and
in response, identifying a second database having a related configuration parameter value for the query type and a comparable expected performance value range to the received expected performance value range for the query.

17. The system of claim 16, wherein the first database and the second database are selected from the group consisting of a row-oriented database, a column-oriented database, an SQL engine, a NoSQL database, a graph database, an object-oriented database, and an in-memory database.

18. The system of claim 11, wherein the first configuration parameter value is selected from the group consisting of a size of available memory, a buffer size, a central processing unit (CPU) type, a number of CPUs, a number of threads per CPU, a number of partitions of the first database, a number of shards, and a geographical location of the first database.

19. The system of claim 11, wherein the measured execution parameter value is an execution time or specification of required resources.

20. A computer program product for runtime optimization of a database hosting system, comprising:
one or more computer-readable storage media; and
program instructions stored on the one or more computer-readable storage media to perform operations comprising:
receiving, by the database hosting system, a query having a query type and an expected performance value range for the query, wherein lower performance values indicate better performance;
selecting, by the database hosting system, a first database having a first configuration parameter value that, when used to execute a previous query of the query type, resulted in an execution performance value within the received expected performance value range;
executing the query by the selected first database;
measuring an execution parameter value for the executing the query;
determining, by the database hosting system, that the measured execution parameter value is below a lower threshold value of the received expected performance value range; and
adjusting a configuration of the database hosting system, wherein the adjusting comprises identifying, by the database hosting system in response to the determining, a second configuration parameter value for the first database such that executing a next query of the query type requires fewer computing resources than the executing the query using the first configuration parameter.
